(19) United States
(12) Patent Application Publication
(10) Pub. No.: US 2008/0172582 A1
(43) Pub. Date: Jul. 17, 2008

(54) METHOD AND SYSTEM FOR PROVIDING PEER LIVENESS FOR HIGH SPEED ENVIRONMENTS

(76) Inventors: David Sinicrope, Cary, NC (US); Jim Comen, Raleigh, NC (US)

Correspondence Address: ERICSSON INC., 6300 LEGACY DRIVE, M/S EVR 1-C-11, PLANO, TX, 75024, US

(21) Appl. No.: 11/622,655

(22) Filed: Jan. 12, 2007

(51) Int. Cl. G06F 11/07

(52) U.S. Cl. 714/48; 714/E11.021

(57) ABSTRACT

Security peer failure, in a network, is reduced by detecting peer liveness after a session has been established between a first and a second peer utilizing a protocol for setting up a security association. A protocol for detecting faults establishes a session between the first and second peer and the fault detecting session is associated with the security association session. Alternatively the security association may be registered with the fault detecting session. The purpose of registering the fault detecting session and the security association session is to determine liveness of the security association peer and when the fault detecting session fails, the peer is notified to take corrective action.

### BACKGROUND

This application relates generally to data communications over a public or private IP network, and more particularly to a method and arrangement for transporting data packets over an encrypted, and/or authenticated IP network security association utilizing IKE and IPsec security technology

Data packets sent on a network without security features are not secure. Packets sent from a source S to a recipient R may be read and modified by an intermediate node I. While there are some safeguards to protect against these actions (e.g. checksum—operations based on totaling the value of all the bytes in a packet), they are limited in their effectiveness. There is nothing to prevent node I from viewing the contents of a packet which may include confidential items such as bank account numbers. An experienced hacker can modify a packet in such a way that the checksum operation would not detect the modification.

The Internet Protocol Security (IPsec) suite of protocols defines methods that prevent an intermediate node from viewing and/or modifying a packet such that the modification would not be detected by the recipient. IPsec allows a source and recipient to negotiate a method of encryption and/or authentication to protect packets between the two nodes, thereby creating a protected, virtual tunnel through a network. The creation of the virtual tunnel is based on a secure negotiation between a source and recipient. This secure negotiation is known as IKE, Internet Key Exchange.

The nodes that use IKE to create a virtual tunnel are known as IKE peers. The name, Internet Key Exchange, is somewhat of a misnomer as keys are not exchanged; rather data is exchanged that allows the IKE peers to independently create identical authentication and encryption keys in parallel.

IKE is used to negotiate the type of tunnel (encryption and/or authentication) and the encryption and authentication keys. When a source desires to send a packet securely, it will first check to see if a virtual tunnel to the recipient exists. If so, the packet is sent on the virtual tunnel. If the secure tunnel does not exist, IKE is used to negotiate a secure tunnel between the source and recipient. In fact, there are two virtual tunnels negotiated.

In IPsec terms, the tunnels are known as Security Associations (SA). IKE SAs are negotiated between IKE peers. An IKE peer is a node capable of participating in an IKE negotiation. The source and recipient nodes may themselves be IKE peers or there may be other nodes which are IKE peers that negotiate an IKE SA on behalf of the source and recipient.

As a first step, IKE peers negotiate an IKE SA which is a secure tunnel between the IKE peers and is used to carry IKE protocol traffic. Once the IKE SA is in place, the IKE peers negotiate an IPsec SA which is a secure tunnel used to carry traffic between the source and recipient. In essence, the IKE SA is a tunnel used to securely negotiate IPsec SAs. In fact, multiple IPsec SAs may be negotiated using a single IKE SA.

Both the IKE and IPsec SAs have lifetimes although they differ in their behavior upon expiration. When an IPsec SA is about to expire, the IKE peers will negotiate a replacement IPsec SA and subsequently delete the original IPsec SA. When an IKE SA expires, any existing IPsec SAs which were negotiated using the IKE SA will be deleted, along with the IKE SA.

Bidirectional Forwarding Detection (BFD) BFD is a protocol intended to detect faults in the bidirectional path between two forwarding engines, including physical interfaces, sub-interfaces, data link(s), and to the extent possible, the forwarding engines themselves, with potentially very low latency. BFD operates independently of media, data protocols, and routing protocols. An additional goal is to provide a single mechanism that can be used for liveness detection over any media, at any protocol layer, with a wide range of detection times and overhead, to avoid a proliferation of different methods.

BFD packets are carried as the payload of whatever encapsulating protocol is appropriate for the medium and network. BFD may be running at multiple layers in a system and the context of the operation of any particular BFD session is bound to its encapsulation.

BFD can provide failure detection on many kinds of paths between systems, including direct physical links, virtual circuits, tunnels, MPLS LSPs, multihop routed paths, and unidirectional links (so long as there is some return path, of course.) Multiple BFD sessions can be established between the same pair of systems when multiple paths between them are present in at least one direction, even if a lesser number of paths are available in the other direction (multiple parallel unidirectional links or MPLS LSPs, for example.)

A problem with IKE occurs when one of the IKE peers terminates or fails. There is no keep alive mechanism in IKE to alert one IKE peer when another IKE peer terminates. Consider the following scenario:

Source S wants to send a large quantity of data to Recipient R. (For simplicity, assume that S & R act as IKE peers). Upon sending the first packet, S will negotiate both an IKE and IPsec SA with R and begin sending data traffic on the virtual tunnel, the IPsec SA. After a short time, recipient R fails. The failure of R has no effect on the IPsec SA on S and thus, S will continue sending data. As far as S is concerned, the IPsec SA between R and S is still up. Only when either the IKE SA or IPsec SA expires will R become aware that the IKE peer, R, is no longer up. From the time R fails until SA expiry, all packets on the IPsec SA will be ‘black-holed’, (i.e., transparently discarded or lost). Even if R comes back up, it won't affect the original IPsec SA between R and S. The IKE or IPsec SA lifetime timer in S must expire before S can attempt to reestablish an IPsec SA to R.

There is no third party which maintains the SAs, rather each IKE peer keeps a local record of the SA. Because records of the SA are maintained locally, if one peer fails, this does not affect the local records on the other peer. Consequently, if one peer fails, the other peer is unaware and will continue to send traffic on the SA, but the traffic will not reach its intended destination.

### SUMMARY

This application is directed to detecting security association peer failure in a network after a session has been established between a first and a second peer utilizing a protocol for setting up a security association. A protocol for detecting faults establishes a session between the first and second peer and the fault detecting session is associated with the security association session. Alternatively the security association may be registered with the fault detecting session. The purpose of registering the fault detecting session with the security association session is to determine liveness of the security association. When the fault detecting session detects a fault, indicating a problem with the security association, the IKE peers are notified such that they may take corrective action.

### BRIEF DESCRIPTION OF THE SEVERAL VIEWS OF THE DRAWINGS

For a more complete understanding of the present invention, reference is made to the following detailed description of an embodiment of the invention, taken in conjunction with the accompanying drawings. Corresponding numerals and symbols in the figures refer to corresponding parts in the detailed description unless otherwise indicated

FIG. 1a depicts a high-level signaling diagram of an Internet Key Exchange operation of establishing an IKE session between two routers without peer liveness detection. In this scenario the failed system does not restart.

FIG. 1b illustrates another high-level signaling diagram of an IKE operation without peer liveness detection. In this scenario the failed system restarts.

FIG. 2a depicts a high-level signaling diagram of an IKE operation with Bidirectional Forwarding Detection (BFD) peer liveness detection in accordance with an embodiment of the present invention. In this scenario the failed system does not restart;

FIG. 2b illustrates a high-level signaling diagram of an IKE operation with BFD peer liveness detection in accordance with an embodiment of the present invention. In this scenario the failed system restarts;

FIG. 3 depicts a block diagram of the IKE and BFD Binding state machine in accordance with a preferred embodiment of the present invention; and

### DETAILED DESCRIPTION

IKE can make use of BFD to detect peer liveness and quickly react if a peer has failed. This is crucial to using IKE/IPsec in a high speed environment.

The basic concept is a defined mechanism for binding BFD to IKE such that BFD, with all benefits, can be used as a liveness protocol for IKE.

Without a method to detect peer liveliness, there is the risk of an IKE peer sending packets on an SA to a peer which has failed. Without peer liveliness, this situation could continue until the SA times out which can range from minutes to days. This is not conducive to a high speed networking environment.

Once an IKE SA has been established, a BFD session is established between the two IKE peers and is registered to IKE to determine liveness. If at any point the BFD session goes down, the IKE peers are notified and can take corrective action.

In using BFD, a peer can choose what level of granularity of BFD session it would like. (e.g., per node or system, per internal subsystem, per internal process, etc.) For the purposes of this discussion a BFD session between systems will be assumed.

When an IKE peer wishes to negotiate an IKE SA with a remote peer, it will first negotiate the IKE SA. Once the IKE SA is negotiated, the initiating IKE peer will create (or use an existing) BFD session between the two IKE peers. NOTE: An IPsec SA negotiation, if appropriate, will occur in parallel to the BFD session establishment.

Once an IKE peer has registered with a BFD session to the remote IKE peer, the local IKE peer will monitor the BFD session for timeout. A BFD timeout is an indication that the remote IKE peer has failed. If such a situation occurs, the local IKE peer can take action to delete any IPsec and IKE SAs to the remote peer and reroute the data. This will greatly minimize (milliseconds vs. hours) loss of data. Without BFD, the data loss would continue until the IPsec SA expired (a period of minutes to hours) and a replacement IPsec SA would not be successfully renegotiated until the IKE SA expired (i.e., hours or days). With this invention, once the IKE SA is deleted, a new IKE and IPsec SA can be immediately negotiated (provided that a remote IKE peer is functional). The authentication aspects of BFD can be used to ensure integrity of the BFD messages.

Although the context of the discussion below refers to routers, the concept can be applied to any two IKE/IPsec peers that implement the required protocols (e.g., Unix-based servers, etc.). It is assumed that both peers implement both IKE (v1 or v2) and BFD. Either mode of BFD may be used (Demand or Asynchronous), but Asynchronous mode is recommended. Demand mode could be used as an optimization if SA traffic monitoring can be used in between BFD polling. BFD Echos can also be used if the implementation permits.

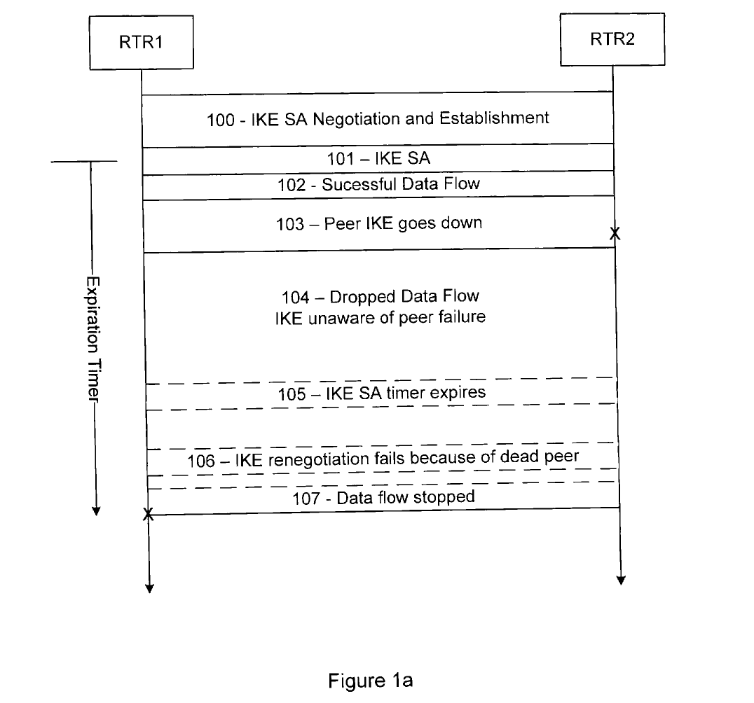

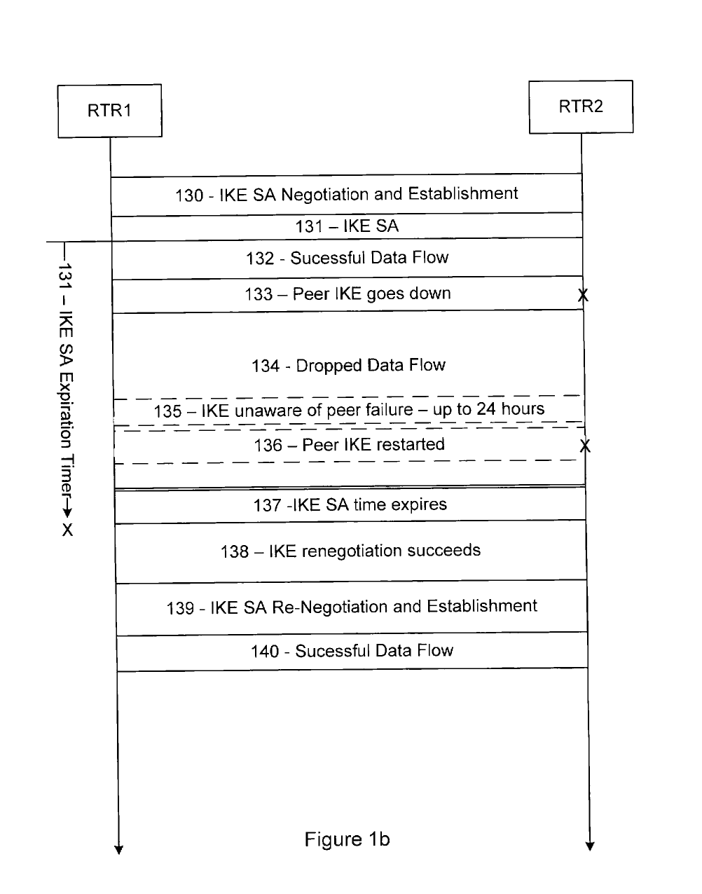

FIG. 1a depicts a signaling diagram having two routers establishing an IKE session between them and beginning data traffic. In this scenario RTR 2 is not restarted. A packet, destined for a host ‘beyond’ RTR2, is received at RTR1 (100). Based on configured security policy, the packet must be encrypted prior to being sent to RTR2. The IKE peer on RTR1 initiates an IKE negotiation with RTR2. Characteristics of the IKE SA, including lifetime (101), are negotiated. Once the IKE SA is created, an IKE SA expiration timer (based on the negotiated IKE SA lifetime) is started, and an IPsec SA (to carry the encrypted data traffic) is negotiated between RTR1 and RTR2. The lifetime of the IPsec SA, normally shorter than the IKE SA lifetime, is also negotiated.

Once the IPsec SA is negotiated and created, data flow over the IPsec SA commences (102). The IPsec SA may timeout and be renegotiated several times while the IKE SA exists. A replacement IPsec SA is negotiated prior to existing IPsec SA expiration to avoid any packet loss.

If RTR2 fails (103), RTR1 receives no indication of the failure. RTR1 continues sending data on the IPsec SA that was negotiated (104/105). All data sent on the IPsec SA will be lost as the remote end of the IPsec SA does not exist (lost when RTR2 failed). If the IPsec SA on RTR1 times out, RTR1 will attempt to renegotiate a replacement, using the IKE SA that was negotiated. However, this renegotiation will fail because the IKE SA is now ‘broken’ since the IKE SA was negotiated with RTR2 before it failed. RTR1 is not currently notified that RTR2 has failed. RTR1 will continue to attempt to communicate with RTR2 over the IKE SA until the IKE SA timer expires, which could be up to 24 hours or longer.

IKE SA on RTR1 expires (105) and RTR1 deletes all IPsec SAs that were negotiated on the IKE SA and then deletes the IKE SA itself. At this point a packet (the first after RTR1 deleted the previous IKE SA), destined for a host ‘beyond’ RTR2, is received at RTR1. Based on configured security policy, the packet must be encrypted prior to being sent to RTR2. The IKE peer on RTR1 initiates an IKE negotiation with RTR2. RTR2, still in a failed state, does not respond (106). The IKE task on RTR1 is unable to negotiate an IKE SA with RTR2 and thus, encrypted data flow between RTR1 and RTR2 stops (107).

FIG. 1b depicts a signaling diagram having two routers establishing an IKE session between them and beginning data traffic. In this scenario RTR2 is restarted after failure. A packet, destined for a host ‘beyond’ RTR2, is received at RTR1 (130). Based on configured security policy, the packet must be encrypted prior to being sent to RTR2. The IKE peer on RTR1 initiates an IKE negotiation with RTR2. Characteristics of the IKE SA, including lifetime, are negotiated. Once the IKE SA is created, an IKE SA expiration timer (based on the negotiated IKE SA lifetime) is started (131), and an IPsec SA (to carry the encrypted data traffic) is negotiated between RTR1 and RTR2. The lifetime of the IPsec SA, normally shorter than the IKE SA lifetime, is also negotiated.

Once the IPsec SA is negotiated and created, data flow over the IPsec SA commences. The IPsec SA may timeout and be renegotiated several times while the IKE SA exists. A replacement IPsec SA is negotiated prior to the existing IPsec SA expiration to avoid any packet loss. (132)

RTR2 may fail but, RTR1 will receive no indication of this event. (133). RTR1 continues sending data on the IPsec SA that was negotiated. All data sent on the IPsec SA will be lost as the remote end of the IPsec SA does not exist (it was lost when RTR2 failed). If the IPsec SA on RTR1 times out, it will attempt to renegotiate a replacement, using the IKE SA that was negotiated. This renegotiation will fail because the IKE SA is now ‘broken’ because it was negotiated with RTR2 before it failed and RTR1 has no notification that RTR2 failed. RTR1 will continue to attempt to communicate with RTR2 over the IKE SA until the IKE SA timer expires, which could be up to 24 hours. (134/135)

If RTR2 restarts and the IKE peer on RTR2 initiates negotiation of an IKE SA to RTR1, the restart of RTR2 will have no effect on RTR1. RTR1 will continue to attempt to use the previously negotiated (now broken) IKE SA. In this scenario, RTR2 is ready to negotiate a new IKE SA but RTR1 already has (what it considers) a valid IKE SA. (136)

The IKE SA on RTR1 expires and RTR1 deletes all IPsec SAs that were negotiated on the IKE SA and then deletes the IKE SA itself. (137) A packet (the first after RTR1 deleted the previous IKE SA), destined for a host ‘beyond’ RTR2, may be received at RTR1. Based on configured security policy, the packet must be encrypted prior to being sent to RTR2. The IKE peer on RTR1 will initiate an IKE negotiation with RTR2. Characteristics of the IKE SA, including lifetime (131) are negotiated. Once the IKE SA is created, an IPsec SA (to carry the encrypted data traffic) is negotiated between RTR1 and RTR2. The lifetime of the IPsec SA, normally shorter than the IKE SA lifetime, is also negotiated. (138/139)

Once the IPsec SA is negotiated and created, data flow over the IPsec SA commences. The IPsec SA may timeout and be renegotiated several times while the IKE SA exists. A replacement IPsec SA is negotiated prior to IPsec SA expiration to avoid any packet loss. (140)

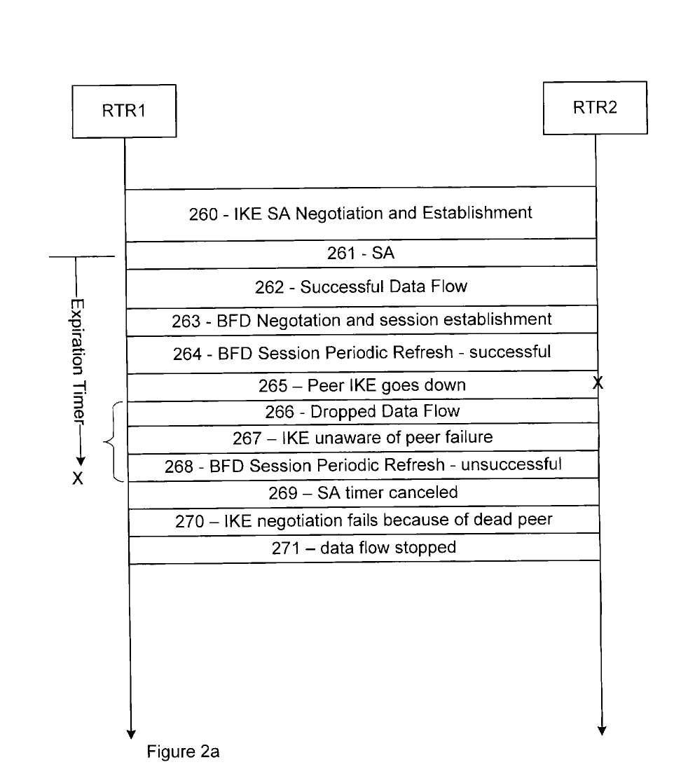

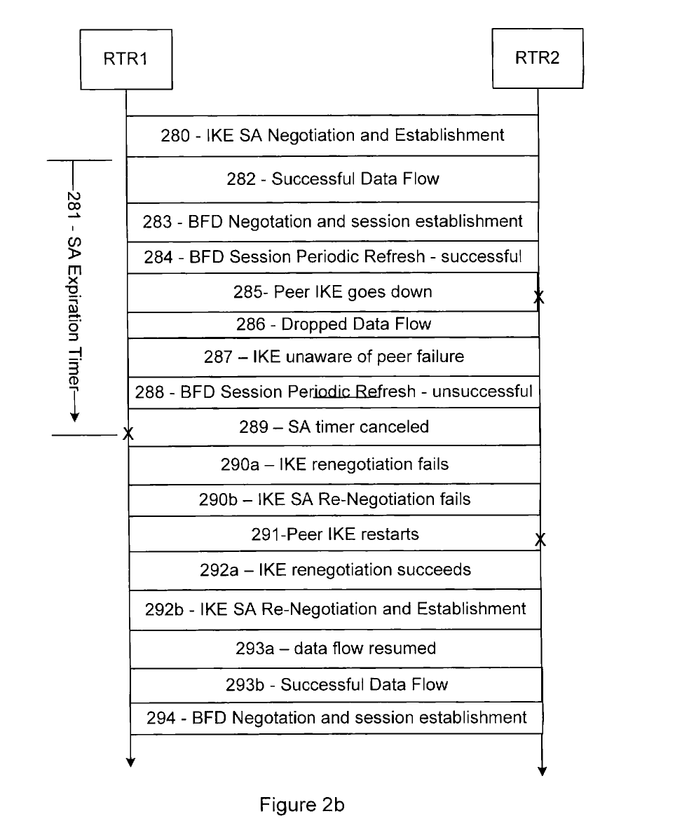

FIG. 2a depicts a high-level signaling diagram of an IKE operation with Bidirectional Forwarding Detection peer liveness detection, in accordance with a preferred embodiment of the present invention. In this scenario RTR2 does not restart.

A packet, destined for a host ‘beyond’ RTR2, may be received at RTR1 and based on configured security policy the packet must be encrypted prior to being sent to RTR2. The IKE peer on RTR1 then initiates an IKE negotiation with RTR2. (260) Characteristics of the IKE SA, including lifetime (261), are negotiated. Once the IKE SA is created, an IKE SA expiration timer (based on the negotiated IKE SA lifetime) is started, and an IPsec SA (to carry the encrypted data traffic) is negotiated between RTR1 and RTR2. The lifetime of the IPsec SA, normally shorter than the IKE SA lifetime, is also negotiated.

BFD negotiation and session establishment (263) and successful data flow (262) are initiated simultaneously and both are triggered based on the creation of an IKE SA.

Once the IPsec SA is negotiated and created, data flow over the IPsec SA commences. The IPsec SA may timeout and be renegotiated several times while the IKE SA exists. A replacement IPsec SA is negotiated prior to IPsec SA expiration to avoid any packet loss. (262)

Once the IKE SA is created, RTR1 registers the IKE SA with BFD and creates a (or uses an existing) BFD session from RTR1 to RTR2. It is assumed that both RTR1 and RTR2 register the IKE SA with a BFD session. Whether they use the same or different BFD sessions is up to the implementation and deployment scenario. (263) When an IKE SA lifetime timer expires, a new IKE SA is established and associated with the existing BFD session.

Periodically, both participants (RTR1 And RTR2) in the BFD session poll each other to determine peer liveness (264). This is much more frequent than waiting for the expiration of the IKE SA timer and is on the order of milliseconds or seconds versus minutes or days.

If RTR2 fails, RTR1 will receive no indication of this event. RTR1 continues sending data on the IPsec SA that was negotiated. All data sent on the IPsec SA will be lost as the remote end of the IPsec SA does not exist (it was lost when RTR2 failed). When the IPsec SA on RTR1 times out, it will attempt to renegotiate a replacement, using the IKE SA that was negotiated. This renegotiation will fail because the IKE SA is broken since it was negotiated with RTR2 before it failed. RTR1 has no notification that RTR2 failed and RTR1 will continue to attempt to communicate with RTR2 over the IKE SA until the BFD session times out (which is on the order of milliseconds). (266/267)

Within a short and configurable (BFD session timeout) time, the BFD session will time out (unsuccessful polls). IKE on RTR1 has been monitoring BFD session and will note the dropped BFD session. (268) IKE on RTR1 will cancel the IKE SA expiration timer, delete IPsec SAs (negotiated on IKE SA) and delete the IKE SA. (269)

A packet (the first after IKE on RTR1 deleted the previous IKE SA), destined for a host ‘beyond’ RTR2, is received at RTR1. Based on configured security policy, the packet must be encrypted prior to being sent to RTR2. The IKE peer on RTR1 initiates an IKE negotiation with RTR2 and since RTR2 (or the IKE task on RTR2) has failed, there is no response. (270) The IKE task on RTR1 is unable to negotiate an IKE SA with RTR2 and thus, encrypted data flow between RTR1 and RTR2 stops. (271)

FIG. 2b illustrates a high-level signaling diagram of an IKE operation with peer liveness detection in accordance with an embodiment of the present invention. In this scenario RTR2 restarts. A packet, destined for a host beyond RTR2, is received at RTR1. Based on configured security policy, the packet must be encrypted prior to being sent to RTR2. The IKE peer on RTR1 initiates an IKE negotiation with RTR2. Characteristics of the IKE SA, including lifetime (280), are negotiated. Once the IKE SA is created, an IKE SA expiration timer (based on the negotiated IKE SA lifetime) is started, and an IPsec SA (to carry the encrypted data traffic) is negotiated between RTR1 and RTR2. The lifetime of the IPsec SA, normally shorter than the IKE SA lifetime, is also negotiated. (280) IKE SA (282) and BFD (283) are initiated simultaneously, both triggered based on the creation of an IKE SA. When an IKE SA lifetime timer expires, a new IKE SA is established and associated with the existing BFD session.

Once the IPsec SA is negotiated and created, data flow over the IPsec SA commences. The IPsec SA may timeout and be renegotiated several times while the IKE SA exists. A replacement IPsec SA is negotiated prior to IPsec SA expiration to avoid any packet loss. (282)

Once the IKE SA is created, RTR1 registers with BFD and creates a (or uses an existing) BFD session from RTR1 to RTR2. The BFD session is registered with IKE running in both RTR1 and RTR2. (283)

Periodically, the BFD session polls to determine peer liveness (284) on the order of milliseconds or seconds versus minutes or days which is much more frequent that waiting for the expiration of the IKE SA timer.

If RTR2 fails, RTR1 will continue to attempt to communicate with RTR2 over the IKE SA until the BFD session times out (which is on the order of milliseconds). (286/287)

Within a short and configurable (BFD session timeout) time, the BFD session will timeout (due to an unsuccessful poll). However IKE, on RTR1, has been monitoring the BFD session and will note the dropped BFD session. IKE will cancel the expiration timer, delete IPsec SAs (negotiated on IKE SA) and delete the IKE SA. Due to the short BFD timeout, the data loss will be minor. (288/289)

A packet (the first after RTR1 deleted the previous IKE SA), destined for a host ‘beyond’ RTR2, may be received at RTR1. Based on configured security policy, the packet must be encrypted prior to being sent to RTR2. The IKE peer on RTR1 initiates an IKE negotiation with RTR2. RTR2 (or the IKE task on RTR2), still failed, does not respond. (290a/290b)

RTR2 restarts (291) and a packet (the first after RTR2 restarted), destined for a host ‘beyond’ RTR2, is received at RTR1. Based on configured security policy, the packet must be encrypted prior to being sent to RTR2. The IKE peer on RTR1 initiates an IKE negotiation with RTR2. Characteristics of the IKE SA, including lifetime (292a/292b), are negotiated. Once the IKE SA is created, an IKE SA expiration timer (based on the negotiated IKE SA lifetime) is started, and an IPsec SA (to carry the encrypted data traffic) is negotiated between RTR1 and RTR2. The lifetime of the IPsec SA, normally shorter than the IKE SA lifetime, is also negotiated.

Once the IPsec SA is negotiated and created, data flow over the IPsec SA commences. The IPsec SA may timeout and be renegotiated several times while the IKE SA exists. A replacement IPsec SA is negotiated prior to IPsec SA expiration to avoid any packet loss. (293a/293b)

Once the IKE SA is created, RTR1 registers with BFD and creates a (or uses an existing) BFD session from RTR1 to RTR2. The BFD session is registered with IKE running in both RTR1 and RTR2. Periodically, the BFD session polls to determine peer liveness (294). This is much more frequent than waiting on the expiration of the IKE SA timer—on the order of milliseconds or seconds versus minutes or days. In this case, the BFD liveness check allows the IKE peers to recover quickly and resume secure communication, thereby limiting data loss.

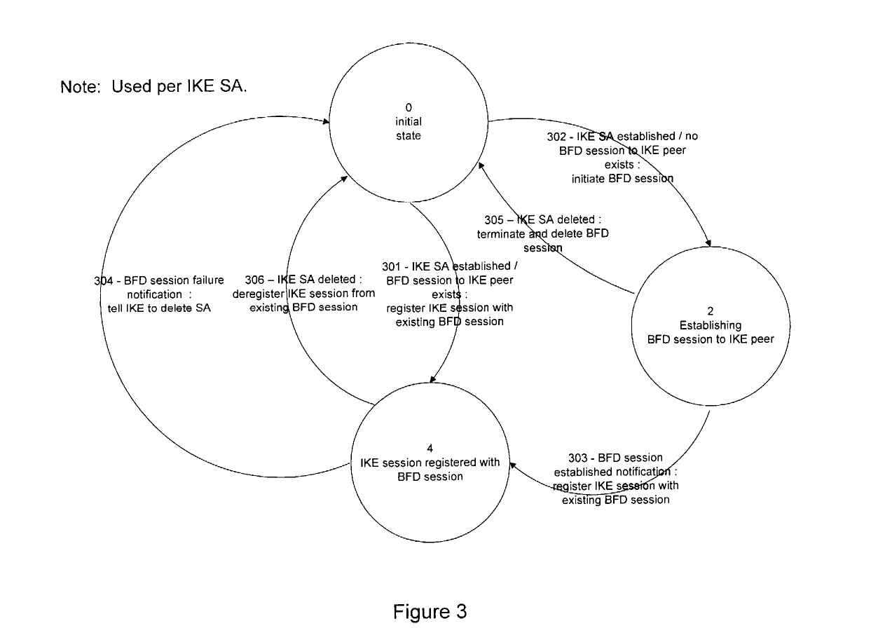

FIG. 3 describes a finite state machine used to control the interaction of IKE and BFD in accordance with a preferred embodiment of the present invention. The finite state machine is the process that controls the interaction of IKE registration with BFD. The registration of BFD and IKE is done through configuration and/or internal messaging. When an IKE session is established, the finite state machine looks for an existing BFD session to the IKE peer router. If one exists (301), the IKE session is registered with the existing BFD session. If there is no existing BFD session available for registering with the IKE peer, the state machine triggers a BFD session to be created (302), and waits for its establishment (State 2). Once the BFD session is established (See FIG. 4), the IKE session is registered to the BFD session (303).

The finite state machine is notified if the BFD session fails, indicating that the remote IKE peer failed. This causes the state machine to tell IKE to remove the corresponding IKE SA and IPsec SA and return to the initial state (304).

If at any point the IKE SA is deleted, either via configuration or a DELETE message, the state machine will also delete the BFD session (if IKE is the only application registered to it) (305) or deregister the IKE SA from the existing BFD session (306) and return to the initial state (305 or 306)

Currently 1 Gb/s link speeds are becoming common in the enterprise, and edge with 10 Gb/s prevalent and increasing to 40 Gb/s in the network core routing spaces. The data loss that can occur is significant if no IKE liveness is used or even if slow IKE liveness is used. The following examples indicate the potential loss and the reduction in losses if BFD IKE liveness is used.

In general, data is lost from the point of destination IKE failure until the source router (e.g., RTR1) detects IKE failure of the destination (e.g., RTR2).

When no IKE liveness is used, the max data loss time possible is the time between IKE negotiations. Even though it can be configured down to the level of seconds, this is impractical and very processor intensive and this interval is typically defaulted to 1, 8 or 24 hours.

When Dead Peer Detection (DPD) is used, the typical refresh time is 60 seconds, with a minimum of 3 lost refreshes before dead peer detection. It can be configured to a refresh time of 1 second, although this is also processor intensive.

When BFD is used, the refresh time is given in milliseconds and for this illustration, we will assume 100 ms and 3 lost refreshes. Table 1 below shows the potential data lost on a 100 Mbps, 1 Gbps, 10 Gbps and a 40 Gbps link for each of the schemes discussed above. (assuming full line utilization)

TABLE 1
Potential data lost during peer detection time (GBytes)

| Potential Data | | | | |
|---|---|---|---|---|
| Lost (in GB) | | | | |
| Dead peer | Link Speeds (Gbps) | | | |
| detection time | 0.1 | 1 | 10 | 40 |
| IKE SA timer | 1080 | 10800 | 108000 | 432000 |
| only 24 hrs | | | | |
| IKE SA timer | 360 | 3600 | 36000 | 144000 |
| only 8 hrs | | | | |
| IKE SA timer | 45 | 450 | 4500 | 18000 |
| only 1 hr | | | | |
| DPD (3 sec) | 0.0375 | 0.375 | 3.75 | 15 |
| IKE w/ BFD | 0.00375 | 0.0375 | 0.375 | 1.5 |
| (300 ms) | | | | |

Data will unlikely be dropped for 24 hrs. However, only one SA is allowed between any two peers, so although the upper layer protocol most likely will time out*, the SA won't be re-established until the SA timer expires. Since the SAs are end-to-end, alternative paths don't help the situation.

Note that not all upper layer protocols have a time out and those that don't time out may send data indefinitely. There is no set IKE SA expiration default, but it is at least as large as IPsec SA default which is 8 hrs. It should also be noted that IKE SA defaults can be set beyond 24 hrs.

There are several technical advantages of this embodiment. Two standard protocols are combined. Typical alternative solutions to the problem are proprietary and when the solutions by different vendors are incorporated, the combination is not likely to be guaranteed to interoperate.

This embodiment is simple in concept and the protocols that are required can be found in nearly all current routers. Other methods that are also based on standards (i.e., using OSPF with GRE tunnels) are not guaranteed to be supported in all implementations. They also complicate network management and topology and don't provide timely detection of failure for high-speed networks, (i.e., their intervals are in seconds, or minutes, not milliseconds)

This embodiment of the invention combines IKE and BFD. This means that BFD can be used in place of existing mechanisms or in addition to existing mechanisms without affecting them. A BFD session can be dedicated to IKE or shared with other protocols. For example, a BFD session may already be established between communicating IKE routers (e.g., for OSPF). The time to react to a failed peer can be as rapid as desired, within the scope of the BFD response time), but the BFD exchanges and timeouts are faster and smaller than existing mechanisms.

Abbreviations

BFD Bidirectional Forwarding Detection

DPD Dead Peer Detection

IKE Internet Key Exchange

IP Internet Protocol

IPSEC IP Security

OAM Operations, Administration and Maintenance

SA Security Association

What is claimed:

1. A method of detecting peer failure on a network, comprising
establishing a session between a first and a second peer, utilizing a protocol for setting up a security association;
establishing a session between the first and the second peer utilizing a protocol for detecting faults;
registering the fault detecting session to the security association session or registering the security association session to the fault detecting session to determine liveness; and
responsive to the fault detecting session failing, notifying the first and second peers to take corrective action.

2. The method of claim 1, wherein the security association protocol is Internet Key Exchange (IKE).

3. The method of claim 1, wherein the fault detecting session is Bidirectional Forwarding Detection (BFD).

4. The method of claim 1, wherein the step of establishing a session utilizing a protocol for setting up a security association, further comprises the first peer negotiating an IKE Security Association (SA) with the second peer.

5. The method of claim 1, wherein the step of establishing a session utilizing a protocol for detecting faults further comprises,
determining whether a BFD session exists between the first and the second peers, if so,
registering the IKE session with the existing BFD session, wherein if no BFD session exists between the first and the second peer
triggering the creation of a BFD session between the first and the second peer.

6. The method of claim 5, wherein the registration of the BFD and IKE sessions follows a state machine controlling the binding of the two sessions,

7. The method of claim 5, wherein an IPsec SA negotiation is initiated at the same time as, or in proximity to the BFD session negotiation.

8. The method of claim 1, further comprising the first peer monitoring the BFD session for a timeout condition.

9. The method of claim 6, wherein if the first peer detects a BFD session timeout, the first peer
deleting the IKE SA and the IPsec SAs;
determining whether the second peer is functional; and
if the second peer is functional, negotiating a new IKE SA and a new IPsec SA;

10. A system for detecting peer failure on a network, comprising
means for establishing a session between a first and second peer utilizing a protocol for setting up a security association;
means for establishing a session between the first and the second peer utilizing a protocol for detecting faults;
means for registering the fault detecting session to the security association session or registering the security association session to the fault detecting session to determine liveness; and
responsive to the fault detecting session terminating, means for notifying the first and second peers to take corrective action.

11. The system of claim 10, wherein the security association protocol is Internet Key Exchange (IKE).

12. The system of claim 10, wherein the fault detecting session is Bidirectional Forwarding Detection (BFD).

13. The system of claim 10, wherein the means for establishing a session utilizing a protocol for setting up a security association, further comprises the first peer comprising means for negotiating an IKE Security Association (SA) with the second peer.

14. The system of claim 10, wherein the means for establishing a session utilizing a protocol for detecting faults further comprises:
means for determining whether a BFD session exists between the first and the second peers, and if the BFD session exists,
means for registering the IKE session with the existing BFD session, wherein if no BFD session exists between the first and the second peer
means for triggering the creation of a BFD session between the first and the second peer.

15. The system of claim 14, wherein the registration of the BFD and IKE sessions follows a state machine controlling the binding of the two sessions,

16. The system of claim 14, wherein an IPsec SA negotiation is initiated at the same time as the BFD session negotiation.

17. The system of claim 10, further comprising means in the first peer for monitoring the BFD session for a timeout condition.

18. The system of claim 17, wherein if the first peer detects a BFD session timeout, the first peer further comprising means for
deleting the IKE SA and the IPsec SA;
determining whether the second peer is functional; and
if the second peer is functional, negotiating a new IKE SA and a new IPsec SA; and a new BFD.
